(19) United States
(12) Patent Application Publication
(10) Pub. No.: US 2002/0177456 A1
(43) Pub. Date: Nov. 28, 2002

(54) Method for transmitting simple message

(75) Inventors: Yousuke Kimoto, Kanagawa (JP); Tomokazu Kake, Tokyo (JP)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Sony Computer Entertainment Inc., Tokyo (JP)

(21) Appl. No.: 10/143,476

(22) Filed: May 10, 2002

(30) Foreign Application Priority Data
May 16, 2001 (JP) 2001-145982
Feb. 26, 2002 (JP) 2002-050352

(51) Int. Cl. H04Q 7/20

(52) U.S. Cl. 455/466; 455/412; 455/413

(57) ABSTRACT

A message to be transmitted is selected from a list which includes the number of times a calling signal is to be sent for each of a plurality of messages. The number of calling signals corresponding to the message to be transmitted is read, and a transmitter controls communication so that the number of transmitted calling signals is limited to the number of calling signals corresponding to the message to be transmitted. A receiver, after a message corresponding to the number of calling signals arriving at the receiver is read from a list, displays the message on a display unit. According to this configuration, a message may be transmitted and received simply and surely under conditions set beforehand without establishing a voice communication line between the transmitter and receiver.

### CROSS-REFERENCE TO RELATED APPLICATIONS

This application claims priority from Japanese Patent Application Nos. 2001-145982 filed on May 16, 2001 and 2002-050352 filed on Feb. 26, 2002, the disclosures of which are hereby incorporated by reference herein.

### BACKGROUND OF THE INVENTION

The present invention relates to a method for transmitting and receiving messages, a method for transmitting messages, a method for receiving messages, a computer-readable storage medium having recorded thereon a message transmission program to be executed on a computer, a computer-readable storage medium having recorded thereon a message reception program to be executed on a computer, a transmitter, a receiver, a transmitter-receiver, a message transmitting and receiving system, a message transmission program to be executed on a computer, and a message reception program to be executed on a computer, all of which are capable of displaying a message transmitted from a communication party on a display unit without a manipulating operation for the incoming signal in the transmitter-receiver, such as, for instance, portable telephones and so forth.

Generally, a caller makes a telephone call in the hope that a communication party will answer the telephone. However, when the communication party is not available, the caller's telephone call to the communication party may result in connection to an answering machine. As a result, although the caller makes a telephone call in the hope that the communication party will answer the telephone, it proves to be disappointing.

In addition to telephones, there is, for instance, electronic mail as a means for transmitting messages to a communication party. In the case of electronic mail, since it is possible to transmit messages regardless of the availability of the communication party, messages may be transmitted when it is convenient for the sender. Thus, the sender of electronic mail transmits the electronic mail without hoping that the communication party will immediately open the transmitted message. Therefore, in the case of electronic mail, the same hope that the message will be immediately received is not created as with telephone calls. However, electronic mail is not capable of notifying the communication party of a message unless he or she activates, for instance, a personal computer and so forth and then executes the mail program on the personal computer.

Thus, the telephone system is not capable of communicating business unless the communication party immediately answers the telephone, and electronic mail is not capable of communicating messages to the communication party unless the communication party activates a personal computer and so forth and then opens the received electronic mail.

### SUMMARY OF THE INVENTION

The present invention has been proposed in consideration of the above-mentioned problems, and an object of the present invention is to provide a method for transmitting and receiving a message, a method for transmitting a message, a method for receiving a message, a computer-readable storage medium having recorded thereon a message transmission program to be executed on a computer, a computer-readable storage medium having recorded thereon a message reception program to be executed on a computer, a transmitter, a receiver, a transmitter-receiver, a message transmitting and receiving system, a message transmission program to be executed on a computer, and a message reception program to be executed on a computer, all of which are capable of transmitting and receiving messages simply and surely under conditions set beforehand without establishing a voice communication line between transmitter-receivers.

The present invention adds the meaning of a message to the number of times a calling signal is sent to a communication party, and is thereby capable of transmitting and receiving messages simply without establishing a voice communication line.

Specifically, the present invention prepares a storage unit having stored therein data in which a unique number of calling signals corresponds to each message, and then a calling signal is sent to a receiver/transmission destination so that the number of calling signals sent corresponds to the message to be transmitted. The receiver/transmission destination reads out the message corresponding to the number of calling signals received from a storage unit in which messages are stored, each in association with a unique number of calling signals, and then displays the message on a display unit.

According to this configuration, even though, for instance, a communication party does not answer the telephone, or the communication party is under any conditions or so forth, a message is capable of being transmitted and received under the predetermined conditions without establishing a voice communication line between the transmitter of the sender and the receiver of the recipient.

Other and further objects and features of the present invention will become obvious upon an understanding of the illustrative embodiments about to be described in connection with the accompanying drawings, or will be indicated in the appended claims, and various advantages not referred to herein will occur to one skilled in the art upon employing the invention in practice.

### BRIEF DESCRIPTION OF THE DRAWINGS

The above and other features will be better understood from the exemplary embodiments described below, taken together with the drawings, of which:

FIG. 1 is a schematic view illustrating the state in which a simple message is transmitted and received between message transmitter-receivers;

FIG. 2 is a block diagram of a message transmitter-receiver at the transmission side;

FIG. 3 is a block diagram of a message transmitter-receiver at the reception side;

FIG. 4 is a flowchart illustrating a transmission process for a simple message;

FIG. 5A is a view illustrating an exemplary display of a registrant list;

FIG. 5B is a view illustrating an exemplary display of a simple message list;

FIG. 5C is a view illustrating an exemplary display of a transmission screen;

FIG. 6 is a flowchart illustrating a display process for a simple message;

FIG. 7 is a view illustrating an exemplary simple message and the number of calling signals related to respective registrants;

FIG. 8A is a view illustrating an exemplary image of an incoming simple message; and

FIG. 8B is a view illustrating an exemplary display of a received simple message;

### DETAILED DESCRIPTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Outline of the Present Embodiment

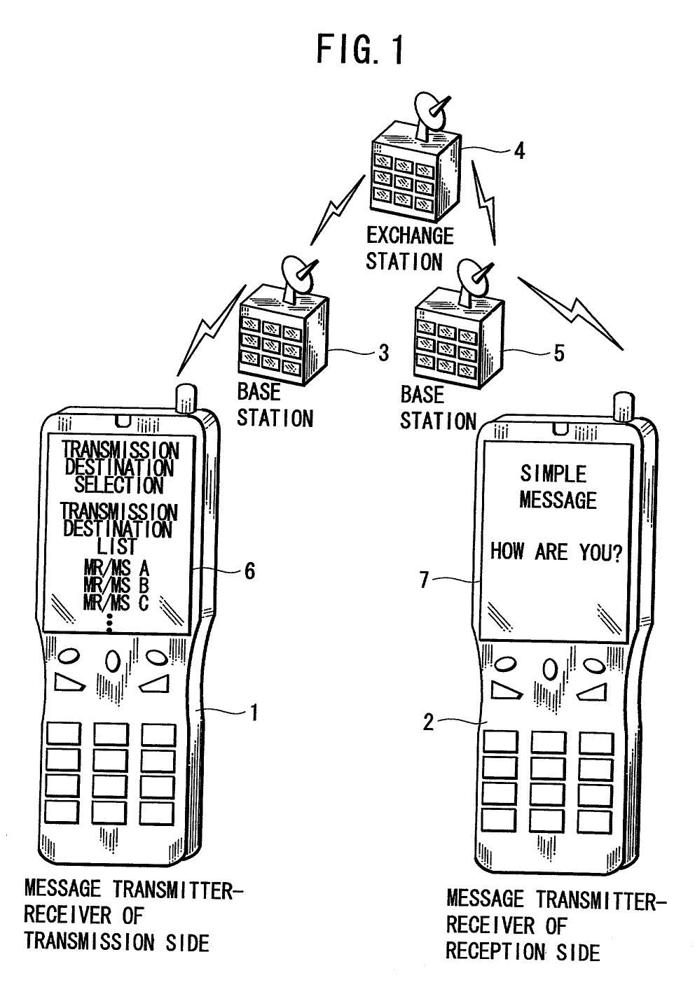

FIG. 1 illustrates an exemplary embodiment in which the present invention is applied to a simple message transmitting and receiving system, where a simple message is capable of being transmitted and received between message transmitter-receivers 1, 2, such as, for example, portable telephones, hand-held information terminals with a telecommunication facility, and so forth.

Specifically, the message transmitter-receiver I provided on the transmission side adds the telephone number of the message transmitter-receiver 2 on the reception side (incoming destination) to line establishment requiring signals, and then sends the line establishment requiring signals to an exchange station 4 via a base station 3 on the transmission side for detecting position information of the message transmitter-receivers 1, 2, thereby establishing a line between the exchange station 4 and the message transmitter-receiver 1. The exchange station 4 establishes a line between the message transmitter-receiver 2 on the reception side and the exchange station 4 via the base station 5 on the reception side. When the line is established, the message transmitter-receiver 1 on the transmission side or the exchange station 4 transmits calling signals to the message transmitter-receiver 2 on the reception side, where the number of times the calling signals are transmitted corresponds to the message desired to be transmitted to the communication party (reception destination).

The message transmitter-receiver 2 receives the calling signal and then detects the sender of the calling signal, and also detects the number of transmissions of the calling signal (the number of times the calling signal has been sent). The message transmitter-receiver 2 then detects the message on the message list related to the sender depending on the number of calling signals received. After that, the message transmitter-receiver 2 displays the message on display unit 7 with a predetermined operation. In this simple message transmitting and receiving system, the number of calling signals received is uniquely related to the message. Accordingly, transmission and reception of a simple message is possible without establishing a voice communication line between the message transmitter-receivers 1, 2.

It should be noted that, as described above, it is alternatively possible that calling signal transmission and control of the number of times the calling signal is transmitted may be performed by the message transmitter-receiver 1 or the exchange station 4, or it is possible that transmission of the calling signal may be performed by the exchange station 4, and control of the number of times the calling signal is transmitted may be performed by the message transmitter-receiver 1. Further, it is possible that transmission of the calling signal may be performed by the message transmitter-receiver 1, and control of the number of times the calling signal is transmitted may be performed by the exchange station 4.

In the present embodiment, it is assumed that the message transmitter-receiver 1 sends information to the exchange station 4 regarding the number of times a calling signal corresponding to a selected message has been transmitted, and the exchange station 4 transmits to the message transmitter-receiver 2 on the reception side calling signals corresponding to the number of transmissions on the basis of the supplied information. In addition, it is assumed that FIG. 1 is an example in which messages are sent from the message transmitter-receiver 1 on the transmission side to the message transmitter-receiver 2 on the reception side. However, in the case where these message transmitter-receivers 1, 2 are provided with functions for transmitting and receiving simple messages, the message transmitter-receivers 1, 2 are capable of transmitting and receiving messages mutually.

Configuration of Portable Telephones

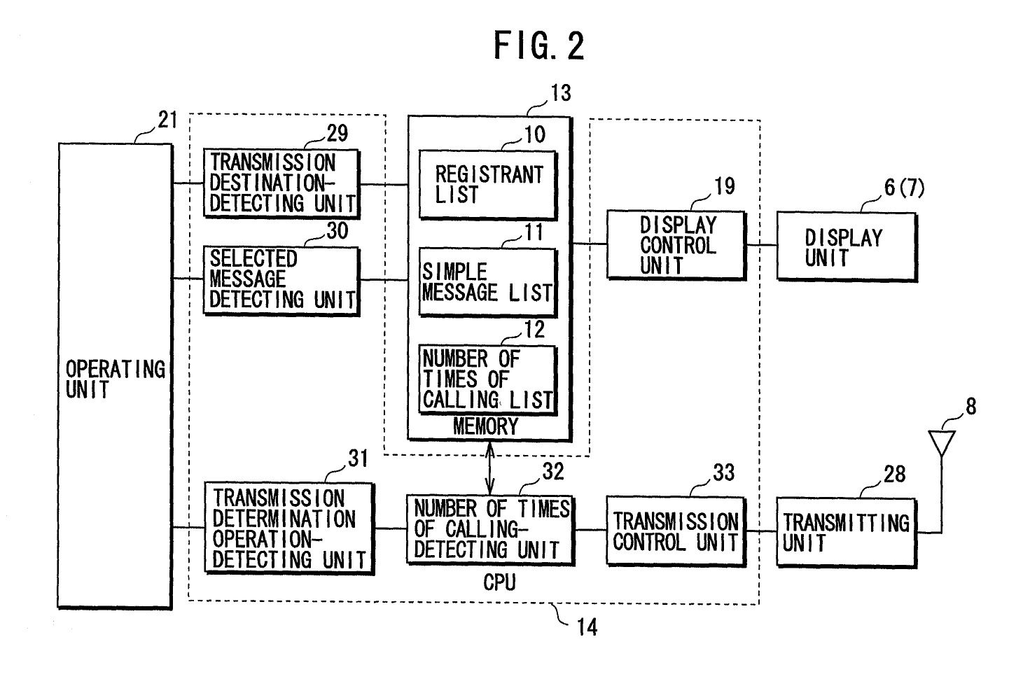

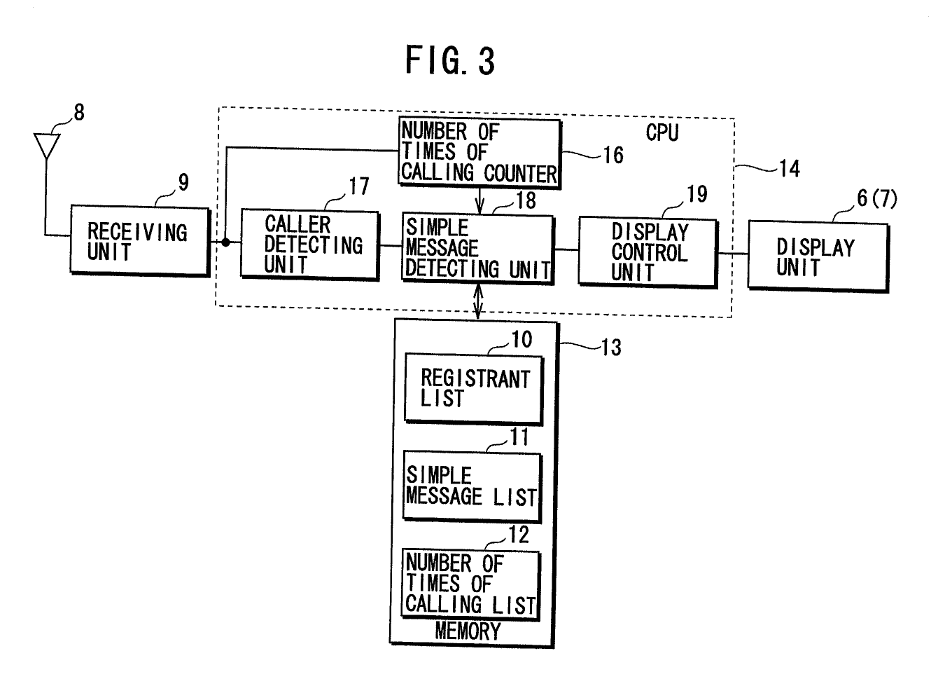

The message transmitter-receivers 1, 2 which are used in the simple message transmitting and receiving system have a transmission system as illustrated in FIG. 2 and a reception system as illustrated in FIG. 3. It should be noted that the message transmitter-receivers 1, 2 on both the transmission side and the reception side have the transmission system and the reception system. Therefore, the configuration of the transmission system and the reception system will be explained with reference to the message transmitter-receiver 1 on the transmission side, for instance, in which the message transmitter-receiver 1 is representative thereof.

Configuration of Transmission System

To begin with, the transmission-system of the message transmitter-receiver 1, as illustrated in FIG. 2, has an operating unit 21 operated by the sender at the time the simple message is transmitted, a memory 13 provided with a registrant list 10, a simple message list 11 and the number of times of calling list 12, a CPU 14 for controlling the number of transmissions of the calling signal (the number of times the calling signal has been sent) that correspond to the simple message to be transmitted to the transmission destination, and a transmitting unit 28 for transmitting via an antenna 8 the information regarding the number of times the calling signal has been sent.

The registrant list 10 of the memory 13 stores therein the names of respective registrants and the telephone numbers of the respective registrants. In addition, the simple message list 11 stores therein a plurality of simple messages, such as, for instance, “Good Morning!”, “Good Night!” and so forth. Further, the number of times of calling list 12 stores therein information indicating the number of calling signals that correspond to each simple message for every respective registrant.

The CPU 14 has a transmission destination-detecting unit 29 for detecting the transmission destination selected by the sender from among the registrant list 10 of the memory 13, a selected message detecting unit 30 for detecting a simple message selected by the sender from among the simple message list 11 of the memory 13, a transmission determination operation-detecting unit 31 for detecting a transmission determination operation by the operating unit 21 with regard to the simple message, and a display control unit 19 for displaying the list of registrants stored in the memory 13, the simple messages corresponding to the registrant and so forth on a display unit 6, such as a liquid crystal display and so forth (display unit 7 in the case of the message transmitter-receiver 2 at the reception side), on the occasion that the operator selects simple messages.

In addition, the CPU 14 has a number of times of calling-detecting unit 32 for detecting information concerning both the transmission destination selected by the sender and the number of calling signals corresponding to the simple message from among the number of times of calling list 12, and a transmission control unit 33 for controlling the transmitting unit 28 so as to transmit information concerning the number of calling signals detected by the number of times of calling-detecting unit 32.

The transmission destination-detecting unit 29 to the transmission control unit 33 operate as functions of the CPU 14 controlled by predetermined computer programs.

Configuration of Reception System

The reception system of the message transmitter-receiver 1, as illustrated in FIG. 3, has a receiving unit 9 for receiving intermittent incoming calling signals via the antenna 8, and a CPU 14 for detecting the sender on the occasion that an incoming calling signal is received, and, when the sender is registered in the registrant list 10 of the memory 13, for reading out from the simple message list 11 a simple message corresponding to the sender depending on the number of calling signals received and then displaying a corresponding simple message on the display unit 6.

The CPU 14 has the number of times of calling counter 16 for counting the number of times the calling signal is intermittently received at the receiving unit 9, a caller detecting unit 17 for detecting the caller, a simple message detecting unit 18 for detecting the simple message corresponding to the number of times the calling signal has been received while retrieving the memory 13 on the basis of both the number of calling signals counted by the number of times of calling counter 16 and the caller detected by the caller detecting unit 17, and a display control unit 19 for displaying the detected simple message and so forth on the display unit 7.

The number of times of calling counter 16 to the display control unit 19 operate as functions of the CPU 14 controlled by predetermined computer programs.

Transmitting and Receiving Operation of Simple Message

The simple message transmitting and receiving operation in the simple message transmitting and receiving system will be explained for the case in which the message transmitter-receiver 2 on the reception side receives a simple message transmitted from the message transmitter-receiver 1 on the transmission side illustrated in FIG. 1.

Transmitting Operation

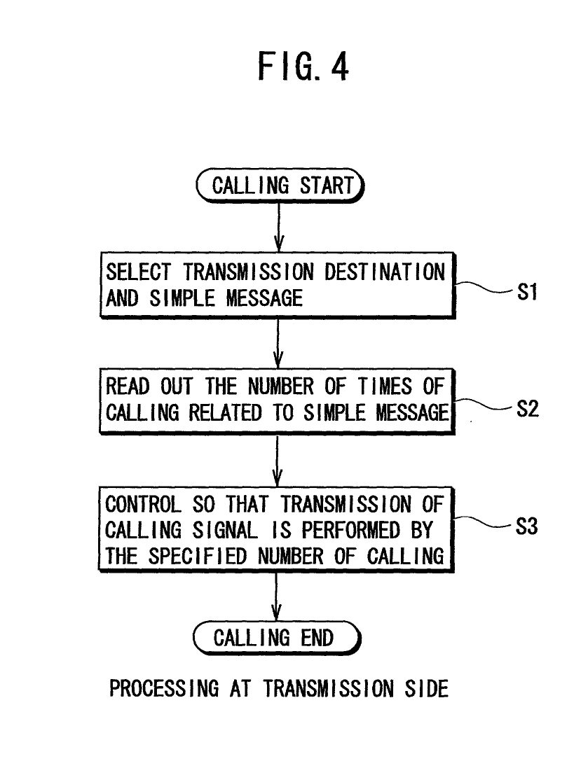

The flowchart of FIG. 4 indicates the process of transmitting a simple message from the message transmitter-receiver 1 provided on the transmission side. The flowchart starts (calling start) when the sender operates the message transmitter-receiver 1 and selects the transmission mode of the simple message.

When this transmission process is started, in STEP S1, the transmission destination-detecting unit 29 and the selected message detecting unit 30 detect the transmission destination of the simple message and the simple message being transmitted, respectively, on the basis of the output from the operating unit 21 operated by the user.

Specifically, in this transmission mode, the transmission destination-detecting unit 29 reads out from the registrant list 10 the list of transmission destinations registered beforehand in the memory 13. Then, the display control unit 19 controls the registrant list 10 and displays it on the display unit 6 as a transmission destination selection screen.

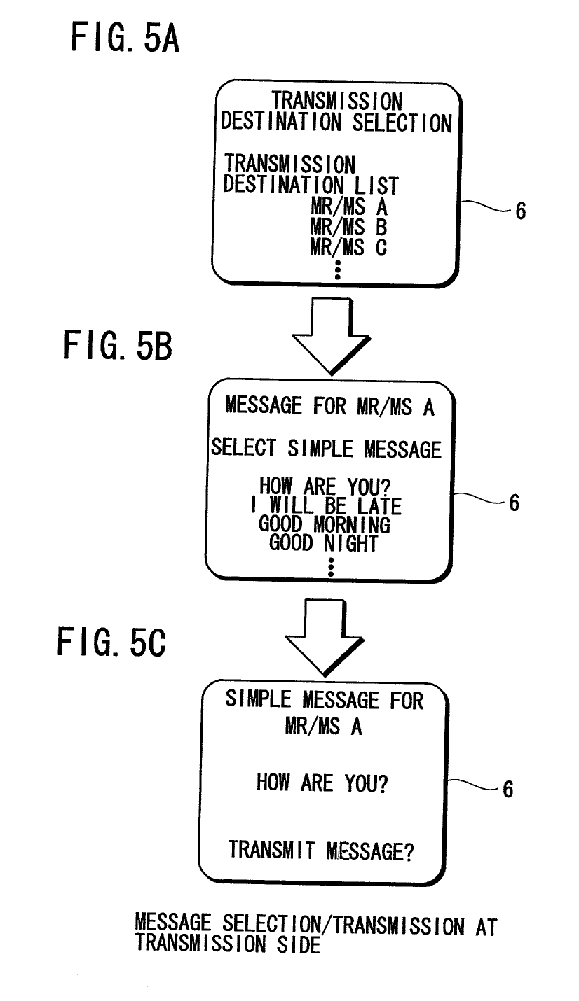

FIG. 5A illustrates an exemplary transmission destination selection screen displayed on the display unit 6. The respective registrants to be transmission candidates for the simple message, as illustrated in FIG. 5A, are displayed in a tabulated list on the display unit 6 by the display control unit 19. For example, the list may be displayed as Mr/Ms. A, Mr/Ms. B, Mr/Ms. C, and so forth.

The user selects the registrant to whom the simple message is to be transmitted from among the respective registrants displayed on the display unit 6 by operating the operating unit 21. The transmission destination-detecting unit 29 detects the transmission destination to be the registrant selected by the user on the basis of the output from the operating unit 21 and then reads out the simple message list that is allocated to the selected registrant beforehand from among the simple message list 11 of the memory 13. The display control unit 19 then controls the simple message list 11 and displays it on the display unit 6.

FIG. 5B illustrates an exemplary simple message list 11 displayed on the display unit 6. The simple message list 11, as illustrated in FIG. 5B, indicates simple messages, such as, for instance, “How are you?”, “I will be late.”, “Good Morning.”, “Good Night.” and so forth, which are displayed on the display unit 6 in a tabulated list.

The user operates the operating unit 21 of the message transmitter-receiver 1 to select the desired simple message from the simple message list 11 that is displayed on the display unit 6. The selected message detecting unit 30 detects the simple message selected by the user on the basis of the output from the operating unit 21 of the message transmitter-receiver 1. When the simple message selected by the user is detected, the display control unit 19, as illustrated in FIG. 5C, controls the display unit 6 to display the simple message selected by the user and a message inquiring as to whether the simple message is to be transmitted.

FIG. 5C illustrates the exemplary simple message of “How are you?” selected by the user, and the exemplary message of “transmit message?” inquiring whether the simple message should be transmitted. These messages are displayed on the display unit 6.

When a transmission instruction is output by the user via the operating unit 21 in response to the transmission inquiry message, the transmission determination operation-detecting unit 31 outputs this transmission instruction to the number of times of calling-detecting unit 32.

The number of times of calling-detecting unit 32, in STEP S2 of the flowchart of FIG. 4, accesses the memory 13 on the basis of the transmission destination detected at the transmission destination-detecting unit 29 and the simple message detected at the selected message detecting unit 30. The number of times of calling-detecting unit 32 detects from the memory 13 the number of times the calling signal allocated to the simple message is to be transmitted to the transmission destination, and provides the detection output to the transmission control unit 33.

Namely, for instance, one time is allocated as the number of calling signals for the simple message of “How are you?” to Mr/Ms A as the transmission destination, and three times is allocated as the number of calling signals for the simple message of “Good morning.” to Mr/Ms A as the transmission destination, and so forth, where the simple message is related to the number of calling signals and the simple messages related to the respective number of calling signals are stored in the memory 13.

It should be noted that a number of two calling signals may be allocated to the simple message of “How are you?” to Mr/Ms B as the transmission destination, which is different from the number of calling signals for Mr/Ms A as the transmission destination. Also, a number of five calling signals may be allocated to the simple message of “Good morning.” to Mr/Ms B as the transmission destination, and so forth, where the number of calling signals for respective simple messages may be determined arbitrarily between the sender and the recipient.

The number of times of calling-detecting unit 32, when the transmission destination is detected at the transmission destination-detecting unit 29, detects the number of calling signals allocated to the simple message to be transmitted to the transmission destination from the number of times of calling list 12 of the memory 13 in STEP S2, and provides the detection output to the transmission control unit 33.

The transmission control unit 33, in STEP S3 of the flowchart of FIG. 4, controls the transmitting unit 28 so that the calling signal is transmitted only a number of times corresponding to the detected number of transmissions of the calling signal (the number of times the calling signal is to be sent). Namely, the transmission control unit 33 controls the transmitting unit 28 so as to transmit information regarding the number of times of transmission of the calling signal (information regarding the number of times the calling signal is to be sent) to the exchange station 4. In addition, the transmission control unit 33 controls the transmitting unit 28 so as to transmit both the telephone number of the transmission destination and the line establishment requiring signal leading up to the incoming call destination to the exchange station 4. According to this process, the transmission process of the simple message illustrated in the flowchart of FIG. 4 is terminated (calling termination).

The transmitting unit 28 transmits information regarding the telephone number of the transmission destination, information regarding the number of calling signals, and the line establishment requiring signal via the antenna 8, and then these transmitted signals are received in the exchange station 4 via the base station 3 of the transmission side illustrated in FIG. 1. The exchange station 4 establishes a line with the message transmitter-receiver 2 of the transmission destination via the base station 5 of the reception side, and, after that, transmits the calling signal to the message transmitter-receiver 2 of the transmission destination only a number of times corresponding to the simple message to be sent to the transmission destination.

Receiving Operation

The following description is an explanation of the receiving operation of the message transmitter-receiver 2 of the simple message transmitting and receiving system as the message transmitter-receiver 2 receives a simple message.

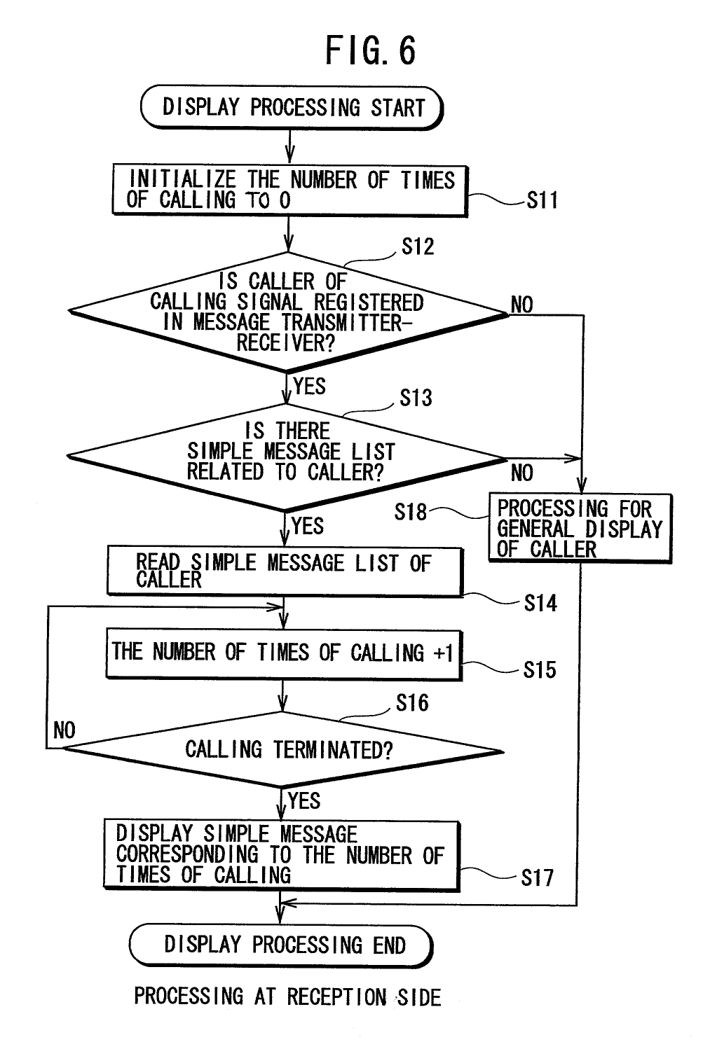

The flowchart of FIG. 6 indicates the process of receiving simple messages in this message transmitter-receiver 2. The receiving process of this flowchart starts (display processing start) at the time the receiving unit 9 illustrated in FIG. 3 detects an incoming calling signal.

The number of times of calling counter 16 of the CPU 14, in STEP S11, initializes the count value of the calling signal to 0 (zero) at the time the calling signal is detected at the receiving unit 9. Then, the receiving process proceeds to STEP S12.

The caller detecting unit 17, in STEP S12, retrieves information regarding the telephone number of the caller transmitted together with the line establishment requiring signal, and then determines whether the information regarding the telephone number of the caller is registered in the information of the telephone numbers of the respective registrants stored in the registrant list 10 of the memory 13 (namely whether the sender is registered in the memory 13 of the message transmitter-receiver 2), and provides the determination output to the simple message detecting unit 18.

When the caller detecting unit 17, in STEP S12, has determined that the sender is registered in the message transmitter-receiver 2, the receiving process proceeds to STEP S13, whereas, when the caller detecting unit 17 has determined that the sender is not registered in the message transmitter-receiver 2, the receiving process proceeds to STEP S18.

The simple message detecting unit 18, in STEP S18, provides information regarding the telephone number of the transmission source to the display control unit 19, and then the display control unit 19 performs general caller display processing to display the information regarding the telephone number on the display unit 6, thereafter terminating the receiving process.

On the other hand, when the caller detecting unit 17 has determined that the caller is registered in the message transmitter-receiver 2 and the receiving process proceeds to STEP S13, the simple message detecting unit 18, in STEP S13, retrieves the registrant list 10 from the memory 13 to determine whether a simple message has been registered with respect to the caller.

When the simple message detecting unit 18, in STEP S13, has determined that there is no simple message registered with respect to the caller, the receiving process proceeds to STEP S18, and the display control unit 19 performs the above-described general caller display processing. On the other hand, when the caller detecting unit 17 determines that there is a simple message registered with respect to the caller, the receiving process proceeds to STEP S14.

The simple message detecting unit 18, in STEP S14, reads the simple message list corresponding to the caller from the simple message list 11 in the memory 13. Next, the number of times of calling counter 16, in STEP S15, counts the number of calling signals received by adding 1 (one) to the count value initialized at STEP S11 for each incoming calling signal detected.

The number of times of calling counter 16, in STEP S16, determines that calling is terminated when it detects the elapse of a definite period of time after the incoming calling signals have stopped, and then provides the count value of the calling signals counted at STEP S15 to the simple message detecting unit 18. After this processing, the receiving process proceeds to STEP S17.

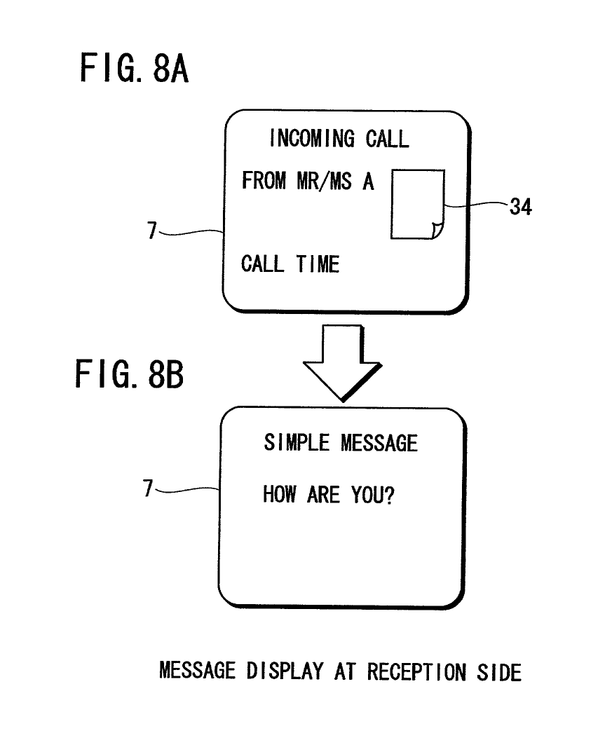

The display control unit 19, when a simple message is detected by the simple message detecting unit 18, for example, as illustrated in FIG. 8A, causes the display unit 7 to display the words “incoming call” indicating that there is an incoming call of a simple message, words indicating the sender of this simple message (in this example, the words “from Mr/Ms A”), the “call time”, and a mark 34 indicating that the simple message has not been read.

The user at the reception side recognizes that his/her message transmitter-receiver 2 has received a simple message by seeing the mark 34, and then operates the operating unit 21 so as to display this simple message.

The simple message detecting unit 18, when detecting the display operation of this operating unit 21, in STEP S17, determines the caller detected by the caller detecting unit 17 and the simple message that corresponds to the number of calling signals detected by the number of times of calling counter 16 from the simple message list read at STEP S14, and then provides the simple message to the display control unit 19. The display control unit 19 displays this simple message on the display unit 7.

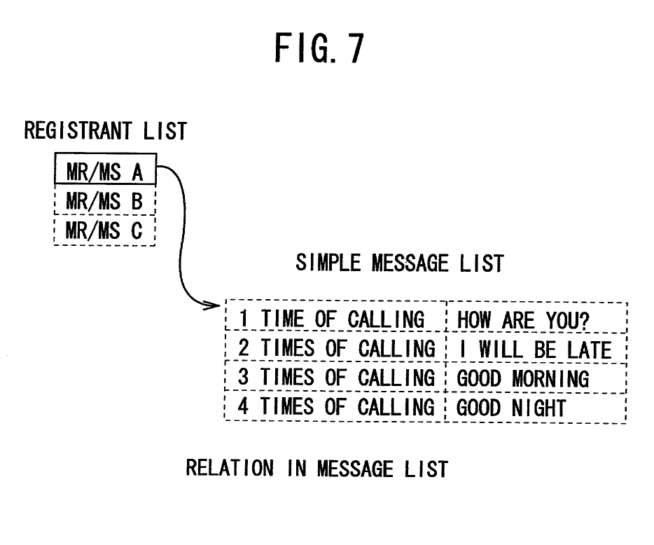

Specifically, for example, in the case where the caller detected by the caller detecting unit 17 is the caller Mr/Ms A, and the number of times the calling signal is detected by the number of times of calling counter 16 is one time, the simple message detecting unit 18, as illustrated in FIG. 7, detects the simple message “How are you?” as the simple message corresponding to the detection of one calling signal from this caller Mr/Ms A from the simple message list 11, and then provides the simple message to the display control unit 19. According to this processing, as illustrated in FIG. 8B, the display unit 7 displays the simple message “How are you?”

It should be noted that, in the case of this example, if two calling signals from the caller Mr/Ms A are detected, the simple message of “I will be late.” is displayed on the display unit 7; if three calling signals from the caller Mr/Ms A are detected, the simple message of “Good morning” is displayed on the display unit 7; and if four calling signals from the caller Mr/Ms A are detected, the simple message of “Good night” is displayed on the display unit 7.

The receiving process illustrated in the flowchart of FIG. 6 is terminated with the display of the simple message.

It should be noted that, generally, the calling signal at the time of transmission and reception has a definite signal length. However, a calling signal that is less than the definite signal length may result when the sender cancels the transmission immediately after transmitting the calling signal or from another factor regarding the calling signals. For that reason, a signal length that is less than the definite signal length at the time of transmission and reception does not count as a calling signal.

For example, the signal length that acts as a reference at the time of counting the calling signals upon transmission or reception is taken to be “1”. When the signal length at the time of transmission or reception is “0.3”, this calling signal is not counted because the signal length “0.3” of this calling signal is less than the signal length “1” of the reference. On the other hand, when the signal length of the calling signal at the time of transmission or reception is a signal length “1.3”, this calling signal is counted because a calling signal with a signal length “1.3” is longer than the signal length “1” of the reference.

Effects of Embodiment

As is clear from the explanation provided above, the simple message transmitting and receiving system of this embodiment uniquely relates the number of calling signals to the message to be sent and adds the meaning of the message to the number of calling signals itself. For that reason, the message is capable of being transmitted to the transmission destination due to the fact that only the number of calling signals corresponding to the message desired to be sent are transmitted without establishing a voice communications line.

The message is transmitted when the sender operates a transmission operation to select the message to be transmitted and the transmission destination of the message, and then a predetermined number of calling signals corresponding to the message to be transmitted are provided to the transmitter-receiver of the transmission destination. For that reason, it is not necessary to conduct troublesome operations, such as inputting the address of the communication party destination, a header and a message in electronic mail and so forth. Thus, the message is capable of being transmitted to the transmission destination with a simple operation and in a short period of time.

In addition, the user is capable of receiving the simple message without operating the message transmitter-receiver 2 consciously, such as in answering the telephone, because the simple message is received automatically by the message transmitter-receiver 2.

The message transmitter-receiver 2 at the reception side, when it receives the simple message, creates a display, such as the mark 34 illustrated in FIG. 8A, to notify the user of the incoming simple message. For that reason, the user is notified of an incoming simple message by this mark 34, even when the simple message is received automatically.

Other Embodiment

The message transmitter-receivers 1, 2, in the above-described embodiment are described as having both the functions of message transmission and reception, however, these message transmitter-receivers 1, 2 may possess only a message transmitting function or only a message receiving function.

The simple message transmitting and receiving system of the above-described embodiment displays a text message corresponding to the number of calling signals detected, however, it is alternatively possible that a static image, a moving image or a voice message may be displayed or output in place of the text message. For example, a static image such as an icon, character and so forth may represent a certain message, and these icons and/or characters are displayed depending on the number of calling signals detected, whereby it is possible to obtain the same effect as described above. In addition, it is possible that text, static images, moving images and voice may be combined appropriately to form a message depending on the number of calling signals detected, and then may be displayed or output as the simple message.

In addition, in the above-described embodiment, the message which corresponds to the number of calling signals detected as agreed upon beforehand between the sender and the recipient is displayed. However, it also may be possible to display fixed simple messages which correspond solely to the number of calling signals detected, and not to the sender. For example, the simple message “How are you?” may be displayed if the number of calling signals detected is one, the simple message “Good morning.” may be displayed if the number of calling signals detected is three, and so forth, regardless of whether the incoming call is from Mr/Ms A or from Mr/Ms B or any other sender.

In addition, in the above-described embodiment, processing at the transmission side and the reception side may be accomplished by reading out a message transmission program or a message reception program stored in the memory within the message transmitter-receiver, or by reading out a message transmission program or a message reception program stored in an external memory.

When the message transmission program or the message reception program is stored in an external memory, the external memory may be connected to a memory slot in the message transmitter-receiver, and the message transmitter-receiver may read out and execute the message transmission program or the message reception program from the external memory.

It is also possible for the message transmission program or the message reception program to be installed on the message transmitter-receiver from a storage medium such as a CD-ROM, DVD-ROM and so forth, or by downloading such programs to the message transmitter-receiver from a predetermined network such as the Internet and so forth.

In addition, the embodiment described-above is an example in which the present invention is applied to a simple message transmitting and receiving system for transmitting and receiving a simple message by using portable telephones. However, the present invention, other than this example, may be applied to any systems which employ communication equipment capable of transmitting calling signals, such as a fixed type (installed type) telephone having a display, such as a liquid crystal display, a facsimile machine, and so forth. The present invention may be used between different apparatuses, for example, where the transmission side is a portable telephone and the reception side is a facsimile machine, or the transmission side is a fixed type telephone and the reception side is a facsimile machine, and so forth.

It should be noted that, in the case that the system employs a facsimile machine, it is possible to output a simple message (or static image or so forth) corresponding to the number of calling signals received by printing the simple message on facsimile paper.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for transmitting a message from a source and receiving the message at a destination, comprising:
establishing at least one predetermined message;
associating each predetermined message with a unique number of calling signals;
storing the at least one predetermined message and the associated number of calling signals in the source and in the destination;
selecting a message from among the at least one predetermined message stored in the source;
determining the number of calling signals associated with the selected message;
transmitting the number of calling signals associated with the selected message to the destination;
counting a number of calling signals received at the destination;
detecting a message that corresponds to the number of calling signals received from among the at least one predetermined message stored in the destination; and
notifying an operator of the destination of the detected message.

2. The method for transmitting and receiving a message according to claim 1, wherein the notifying step includes displaying the detected message on a display.

3. A method for transmitting a message, comprising:
establishing at least one predetermined message;
associating each predetermined message with a unique number of calling signals;
storing the at least one predetermined message and the associated number of calling signals;
selecting a message from among the at least one predetermined message which has been stored;
determining the number of calling signals associated with the selected message; and
transmitting the number of calling signals associated with the selected message.

4. A method for receiving a message, comprising:
establishing at least one predetermined message;
associating each predetermined message with a unique number of calling signals;
storing the at least one predetermined message and the associated number of calling signals;
counting a number of calling signals received; and
detecting a message that corresponds to the number of calling signals received from among the at least one predetermined message which has been stored.

5. The method for receiving a message according to claim 4, wherein the notifying step includes displaying the detected message on a display.

6. A computer-readable storage medium having stored thereon a message transmission program to be executed on a computer, the message transmission program comprising:
establishing at least one predetermined message;
associating each predetermined message with a unique number of calling signals;
storing the at least one predetermined message and the associated number of calling signals;
selecting a message from among the at least one predetermined message which has been stored;
determining the number of calling signals associated with the selected message; and
transmitting the number of calling signals associated with the selected message.

7. A computer-readable storage medium having stored thereon a message reception program to be executed on a computer, the message reception program comprising:
establishing at least one predetermined message;
associating each predetermined message with a unique number of calling signals;
storing the at least one predetermined message and the associated number of calling signals;
counting a number of calling signals received; and
detecting a message that corresponds to the number of calling signals received from among the at least one predetermined message which has been stored.

8. A transmitter, comprising:
a storage unit operable to store at least one predetermined message and a unique number of calling signals associated with each predetermined message;
a selector operable to select a message from among the at least one predetermined message stored in the storage unit;
a detector operable to detect the unique number of calling signals associated with the selected message; and
a controller operable to control the transmission of calling signals so that only the unique number of calling signals are transmitted.

9. A receiver, comprising:
a storage unit operable to store at least one predetermined message and a unique number of calling signals associated with each predetermined message;
a counting unit operable to count a number of calling signals received;
a detector operable to detect a message that corresponds to the number of calling signals received from among the at least one predetermined message stored in the storage unit; and
a notifying unit operable to notify an operator of the receiver of the detected message.

10. The receiver according to claim 9, wherein the notifying unit includes a display operable to display the detected message.

11. A transmitter-receiver, comprising:
a storage unit operable to store at least one predetermined message and a unique number of calling signals associated with each predetermined message;
a selector operable to select a message from among the at least one predetermined message stored in the storage unit;
a first detector operable to detect the unique number of calling signals associated with the selected message;
a controller operable to control the transmission of calling signals;
a counting unit operable to count a number of calling signals received;
a second detector operable to detect messages based on the number of calling signals received; and
a notifying unit operable to notify an operator of the transmitter-receiver of a detected message, wherein
upon transmission of the selected message, the controller controls the transmission of calling signals so that only the unique number of calling signals are transmitted, and
upon receipt of the unique number of calling signals, the second detector detects the message corresponding to the number of calling signals received from among the at least one predetermined message stored in the storage unit, and the notifying unit notifies the operator of the transmitter-receiver of the detected message.

12. The transmitter-receiver according to claim 11, further comprising:
a display operable to display the detected message.

13. A message transmitting and receiving system, comprising:
a transmitter, including:
a first storage unit operable to store at least one predetermined message and a unique number of calling signals associated with each predetermined message;
a selector operable to select a message from among the at least one predetermined message stored in the storage unit;
a first detector operable to detect the unique number of calling signals associated with the selected message; and
a controller operable to control the transmission of calling signals so that only the unique number of calling signals are transmitted; and
a receiver, including:
a second storage unit operable to store the at least one predetermined message and the unique number of calling signals associated with each predetermined message;
a counting unit operable to count a number of calling signals received;
a second detector operable to detect a message that corresponds to the number of calling signals received from among the at least one predetermined message stored in the second storage unit;
a notifying unit operable to notify an operator of the receiver of the detected message; and
an exchange station operable to transmit to the receiver only the unique number of calling signals based on an instruction from the controller.

14. A message transmitting system, comprising:
a processor for executing instructions; and
instructions, the instructions including:
establishing at least one predetermined message;
associating each predetermined message with a unique number of calling signals;
storing the at least one predetermined message and the associated number of calling signals;
selecting a message from among the at least one predetermined message which has been stored;
determining the number of calling signals associated with the selected message; and
transmitting the number of calling signals associated with the selected message.

15. A message receiving system, comprising:
a processor for executing instructions; and
instructions, the instructions including:
establishing at least one predetermined message;
associating each predetermined message with a unique number of calling signals;
storing the at least one predetermined message and the associated number of calling signals;
counting a number of calling signals received; and
detecting a message that corresponds to the number of calling signals received from among the at least one predetermined message which has been stored.
